(19) United States
(12) Patent Application Publication
(10) Pub. No.: US 2022/0397228 A1
(43) Pub. Date: Dec. 15, 2022

(54) HEAT INSULATING STRUCTURE, HEAT INSULATING BODY, METHOD FOR MANUFACTURING HEAT INSULATING STRUCTURE, AND METHOD FOR MANUFACTURING HEAT INSULATING BODY

(71) Applicant: MITSUBISHI HEAVY INDUSTRIES, LTD., Tokyo (JP)

(72) Inventor: Makoto INOMOTO, Tokyo (JP)

(21) Appl. No.: 17/777,469

(22) PCT Filed: Oct. 16, 2020
(86) PCT No.: PCT/JP2020/039024

§ 371 Date: May 17, 2022

(30) Foreign Application Priority Data
Nov. 26, 2019 (JP) 2019-213414

(51) Int. Cl. F16L 59/147; B32B 5/02; B32B 27/12; B32B 1/08

(52) U.S. Cl. CPC F16L 59/147; B32B 5/02; B32B 27/12; B32B 1/08; B32B 2262/0261; B32B 2260/023; B32B 2260/046; B32B 2307/304

(57) ABSTRACT

The purpose of the present invention is to provide a heat insulating structure, a heat insulating body, a method for manufacturing a heat insulating structure, and a method for manufacturing a heat insulating body that can substantially reduce a manufacturing cost and a manufacturing time. A heat insulating structure is provided with: a plurality of partition members that are reticulately provided in a space region between one wall part and another wall part opposed to the one wall part and partition the space region into a plurality of partition spaces from the side of the other wall part to the side of the one wall part; and a plurality of fraction members that are provided to support the one wall part and fractionize partition spaces facing the one wall part among the plurality of partition spaces so as to be gradually smaller toward the side of the one wall part.

### TECHNICAL FIELD

The present disclosure relates to a heat insulating structure, a heat insulating body, a method for manufacturing a heat insulating structure, and a method for manufacturing a heat insulating body.

### BACKGROUND ART

When a product or a structure requires heat insulation, a heat insulating material is generally attached by carrying out construction work. For example, PTL 1 discloses a technique of covering an outer peripheral surface of a pipe with a heat insulating fiber layer and a coating layer. However, additional processing is required to attach the heat insulating material. Accordingly, the additional processing increases labor costs. A branch portion or an elbow portion requires work for cutting and bonding the heat insulating material by aligning the heat insulating material with a shape of the branch portion or the elbow portion, or work for fitting the heat insulating material to the shape. Consequently, workability is reduced. In a case of traffic systems such as automobiles, trains, and aircraft, enough space may not be available in a pipe area to secure a wide living space in many cases. In this case, the workability of the additional work of the heat insulating material is poor. Accordingly, the labor costs increase.

Therefore, a method for manufacturing a heat insulating material by using a three-dimensional additive manufacturing machine (3D printer) has received attention. For example, PTL 2 has been reported as a modeling technique for manufacturing the heat insulating material by using the 3D printer. When the heat insulating material is manufactured by using the 3D printer, the heat insulating material can be manufactured at a relatively low cost, and can be easily increased in size. In manufacturing the heat insulating material by using the 3D printer, it is conceivable to adopt a fused filament fabrication (FFF) method.

### CITATION LIST

### Patent Literature

[PTL 1] Japanese Unexamined Patent Application Publication No. 2016-194360
[PTL 2] PCT Japanese Translation Patent Publication No. 2019-513600

### SUMMARY OF INVENTION

### Technical Problem

However, when the heat insulating material is manufactured by using the 3D printer, it is necessary to prepare a surplus part, which is called a support material, in an overhang part due to a mechanism of stacking a molten resin from above. Therefore, since the support material is prepared, material costs (costs) and manufacturing time inevitably increase. In addition, in some cases, the support material may be less likely to be removed depending on a position where the support material is prepared.

In this way, reducing costs and manufacturing time, which are required for manufacturing the heat insulating material, is an issue. In addition, there is a demand for the heat insulating material having sufficient heat insulation.

The present disclosure is made in view of the above-described circumstances, and an object of the present disclosure is to provide a heat insulating structure, a heat insulating body, a method for manufacturing a heat insulating structure, and a method for manufacturing a heat insulating body, which can sufficiently reduce manufacturing costs and manufacturing time.

Another object of the present disclosure is to provide a heat insulating body having sufficient heat insulation and a method for manufacturing the heat insulating body.

### Solution to Problem

According to the present disclosure, in order to solve the above-described problem, there is provided a heat insulating structure including a plurality of partition members provided in a mesh shape in a space region between one wall part and the other wall part facing the one wall part, and partitioning the space region into a plurality of partition spaces from a side of the other wall part to a side of the one wall part; and a plurality of fraction members provided to support the one wall part, and fractionizing the partition space facing the one wall part among the plurality of partition spaces to be gradually smaller toward the side of the one wall part.

According to the present disclosure, there is provided a method for manufacturing a heat insulating structure. The method includes a partitioning step of providing a plurality of partition members in a mesh shape in a space region between one wall part and the other wall part facing the one wall part, and partitioning the space region into a plurality of partition spaces from a side of the other wall part to a side of the one wall part; and a fraction step of providing a plurality of fraction members to support the one wall part in the partition space facing the one wall part among the plurality of partition spaces, and fractionizing the partition space facing the one wall part to be gradually smaller toward the side of the one wall part.

### Advantageous Effects of Invention

In the heat insulating structure and the method for manufacturing the heat insulating structure of the present disclosure, the wall part is sufficiently supported by each of the fraction members. Therefore, a configuration can be adopted so that preparing the support material for supporting the wall part is not required when the heat insulating structure is manufactured by using the 3D printer. In this manner, carrying out work for removing the support material from the manufactured heat insulating structure is not required. In addition, it is possible to reduce costs and time required for preparing the support material when the heat insulating structure is manufactured by using the 3D printer. Therefore, it is easy to integrally manufacture the wall part and the heat insulating structure.

### BRIEF DESCRIPTION OF DRAWINGS

FIG. 1A is a perspective view of a pipe serving as a heat insulating body to which a heat insulating structure according to a first embodiment of the present disclosure is applied.

FIG. 1B is a cross-sectional view of the pipe in FIG. 1A.

FIG. 1C is an enlarged view of a part surrounded by a two-dot chain line in FIG. 1B.

FIG. 1D is an enlarged view of a vicinity of an outer surface of one wall part in FIG. 1C.

FIG. 1E is an enlarged view of a part surrounded by a broken line in FIG. 1B.

FIG. 1F is an enlarged view of a vicinity of an outer surface of the other wall part in FIG. 1E.

FIG. 2A is a schematic perspective view illustrating an example of a 3D printer using an FFF method.

FIG. 2B is a schematic view illustrating a state where a plastic filament is extruded by the 3D printer in FIG. 2A.

FIG. 3 is a perspective view illustrating a state where heat insulating bodies according to a second embodiment of the present disclosure are aligned.

FIG. 4 is a graph illustrating results obtained by measuring thermal conductivity in an in-plane direction and an out-of-plane direction of the heat insulating body according to the second embodiment of the present disclosure.

FIG. 5A is a perspective view illustrating an example of a pipe serving as the heat insulating body according to the second embodiment of the present disclosure.

FIG. 5B is a perspective view illustrating another example of the pipe serving as the heat insulating body according to the second embodiment of the present disclosure.

### DESCRIPTION OF EMBODIMENTS

Hereinafter, embodiments of a heat insulating structure, a heat insulating body, a method for manufacturing a heat insulating structure, and a method for manufacturing a heat insulating body according to the present disclosure will be described with reference to the drawings.

### First Embodiment

[Heat Insulating Structure]

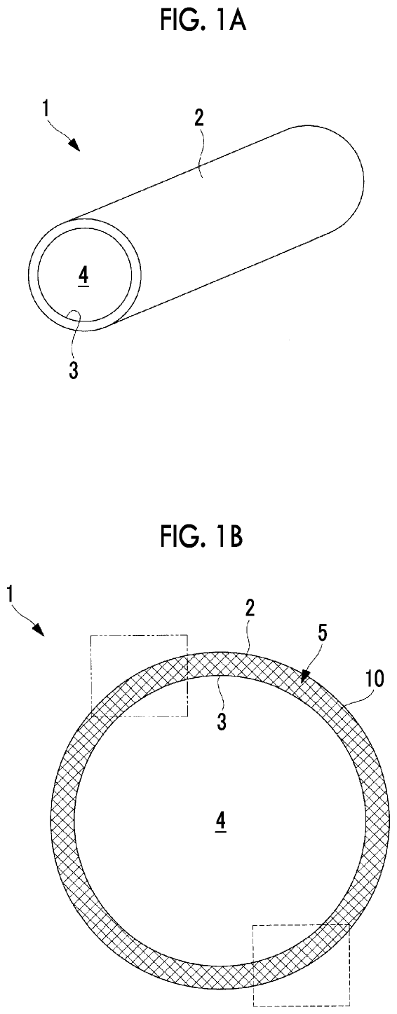

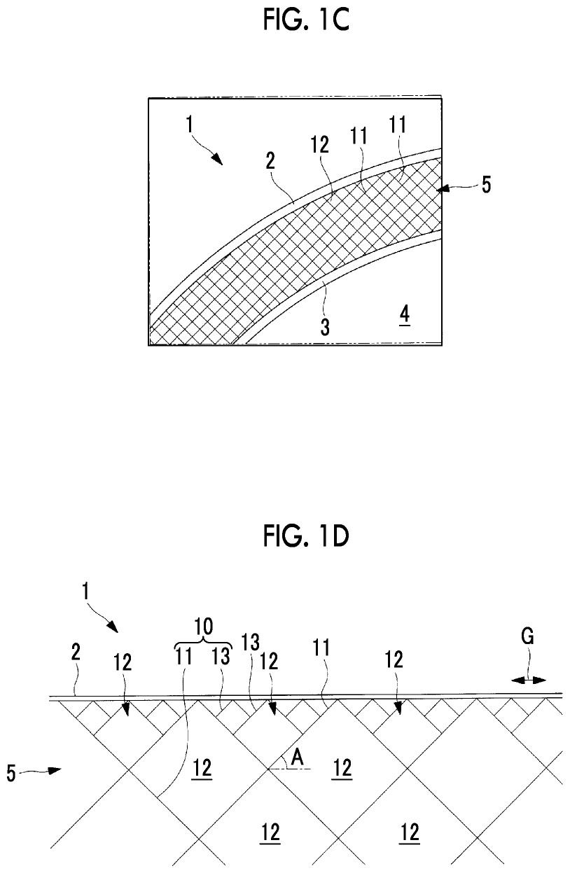

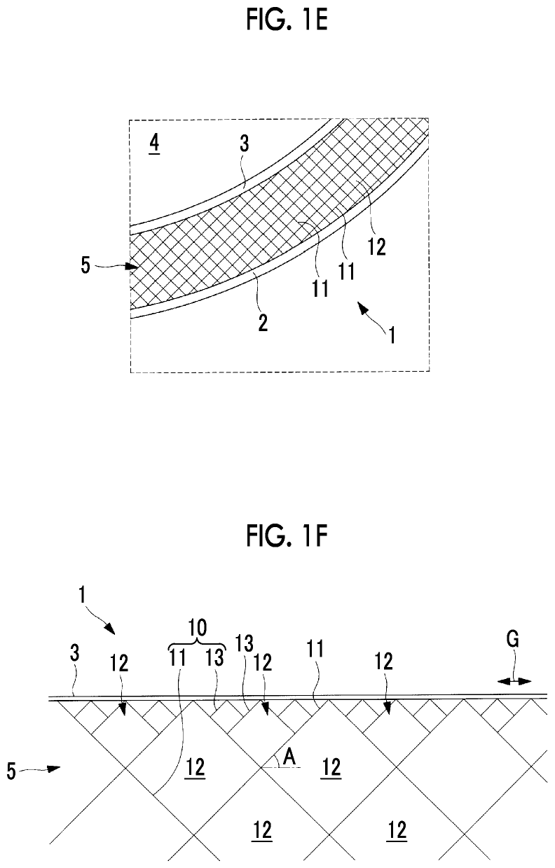

Hereinafter, a first embodiment of the present disclosure will be described with reference to FIGS. 1A to 1F.

FIG. 1A is a perspective view of a pipe serving as a heat insulating body to which a heat insulating structure according to the present embodiment is applied.

A pipe (heat insulating body) 1 includes a skin layer (one wall part) 2 and a skin layer (the other wall part) 3 facing the skin layer 2. The skin layer 2 and the skin layer 3 have an annular shape in a cross-sectional view, and are formed in a pipe shape. A diameter of the skin layer 3 is smaller than a diameter of the skin layer 2, and the skin layer 2 covers a periphery of the skin layer 3. A flow path 4 through which a fluid flows is formed on an inner peripheral surface side of the skin layer 3. The skin layers 2 and 3 are formed of a resin, for example. As illustrated in FIGS. 1A to 1F, when manufactured, the pipe 1 is horizontally disposed in a longitudinal direction.

FIG. 1B is a cross-sectional view of the pipe in FIG. 1A.

As illustrated in FIG. 1B, a space region 5 having an annular shape in a cross-sectional view is formed between the skin layer 2 and the skin layer 3. In the space region 5, a heat insulating structure 10 is provided over the whole space region 5. The heat insulating structure 10 is continuously provided along the longitudinal direction of the pipe 1. The heat insulating structure 10 is formed of a resin, for example.

FIG. 1C is an enlarged view of a part (a part of an upper part in a cross section of the pipe 1) surrounded by a two-dot chain line in FIG. 1B.

As illustrated in FIG. 1C, a plurality of partition members 11 are provided in a mesh shape in the space region 5. The space region 5 is partitioned into a plurality of partition spaces 12 from the skin layer 3 side to the skin layer 2 side by the partition members 11. The partition member 11 is continuously provided along the longitudinal direction of the pipe 1. For example, the partition space 12 can be a space having a grid shape, a truss shape, or a honeycomb shape.

FIG. 1D is an enlarged view of a vicinity of an outer surface of one wall part (skin layer 2) in FIG. 1C.

As illustrated in FIG. 1D, in an upper part of a cross section of the pipe 1, a plurality of fraction members 13 are provided in the partition space 12 facing the skin layer 2 among the partition spaces 12 formed in the space region 5. Each of the fraction members 13 is provided to support the skin layer 2. The partition space 12 facing the skin layer 2 is fractionized by the fraction members 13 to be gradually smaller toward the skin layer 2 side. In this manner, a gap G between the fraction members 13 is shortened closer to the skin layer 2 side. The gap G is preferably equal to or smaller than a maximum gap amount (approximately 5 mm) that can be bridged (can be connected by tension of a resin). In this manner, preparing a support material for supporting the skin layer 2 in the upper part of the cross section of the pipe 1 is not required, for example, when the heat insulating structure 10 is manufactured by using a 3D printer. The fraction member 13 is continuously provided along the longitudinal direction of the pipe 1.

An inclination angle A with respect to a horizontal plane in each of the partition members 11 is preferably 45° or larger.

Although not illustrated, in the upper part of the cross section of the pipe 1, providing the fraction member 13 in the partition space 12 facing the skin layer (the other wall part) 3 among the partition spaces 12 formed in the space region 5 is not required. In the upper part of the cross section of the pipe 1, in a case where the fraction member 13 is not provided in the partition space 12 facing the skin layer 3, when the heat insulating structure 10 is manufactured by using the 3D printer, the support material is prepared in the partition space 12 facing the skin layer 3.

FIG. 1E is an enlarged view of a part surrounded by a broken line in FIG. 1B (portion of a lower part in the cross section of the pipe 1). FIG. 1F is an enlarged view of a vicinity of an outer surface of the other wall part (skin layer 3) in FIG. 1E. As illustrated in FIGS. 1E and 1F, in the lower part of the cross section of the pipe 1 such as a part surrounded by the broken line in FIG. 1B, contrary to the above-described configuration, the fraction member 13 is provided in the partition space 12 facing the skin layer 3. In this manner, preparing the support material for supporting the skin layer 3 in the lower part of the cross section of the pipe 1 is not required, for example, when the heat insulating structure 10 is manufactured by using the 3D printer.

For example, the heat insulating structure 10 can be manufactured by using the 3D printer. Specifically, in various modeling methods, it is possible to manufacture the heat insulating structure 10 by means of a 3D printer using a fused filament fabrication (FFF) method. The FFF method has a simpler mechanism than other methods. Therefore, a device price is low, and the FFF method is widely used from model manufacturing to aircraft component manufacturing.

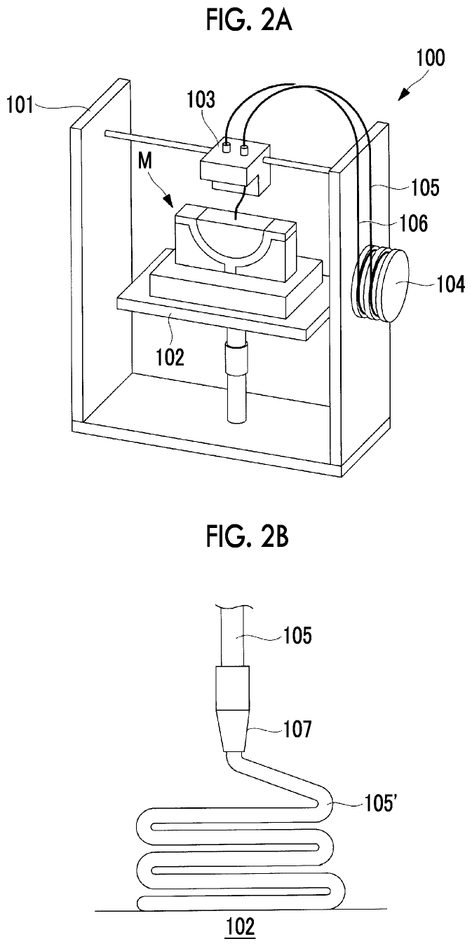

FIG. 2A is a schematic perspective view illustrating an example of the 3D printer using the FFF method.

A 3D printer (three-dimensional additive manufacturing machine) 100 includes a housing 101, a modeling table 102 for modeling which is provided inside the housing 101, and a modeling head 103 provided above the modeling table 102. A modeled object M is modeled on the modeling table 102. A reel 104 is provided outside the housing 101. Each end side of a plastic filament 105 serving as a modeling material and of a support material filament 106 is wound around the reel 104. Each of the other end sides of the plastic filament 105 and of the support material filament 106 is connected to the modeling head 103 so that the plastic filament 105 and the support material filament 106 can be supplied to the modeling head 103.

FIG. 2B is a schematic view illustrating a state where the plastic filament is extruded by the 3D printer 100 in FIG. 2A. For convenience of description, the modeling head 103 in FIG. 2A is omitted in the illustration.

A nozzle 107 for ejecting the plastic filament 105 is provided in the modeling head 103. The nozzle 107 ejects a supplied plastic filament 105′ in a molten or semi-molten state so that the plastic filament 105′ is linearly extruded onto the modeling table 102. The ejected plastic filament 105′ is cooled and solidified to form a layer having a predetermined shape. An operation for ejecting the plastic filament 105′ is repeatedly performed on the formed layer so that the plastic filament 105′ is extruded from the nozzle 107, thereby forming a three-dimensional modeled object.

An operation and an advantageous effect of the heat insulating structure 10 according to the above-described present embodiment will be described.

The heat insulating structure 10 according to the present embodiment includes a plurality of partition members 11 provided in a mesh shape in a space region 5 between two wall parts 2 and 3 (one wall part 2 and the other wall part 3), and partitioning the space region 5 into a plurality of partition spaces 12. In this manner, a portion between the two wall parts 2 and 3 can be sufficiently supported. The partition member 11 has a sparse structure having the mesh shape. Therefore, air can be sufficiently interposed between the respective partition spaces 12. In this manner, the portion between the two wall parts 2 and 3 can be sufficiently insulated.

The heat insulating structure 10 according to the present embodiment includes a plurality of fraction members provided to support the one wall part 2, and fractionizing the partition space 12 facing the one wall part 2 among the plurality of partition spaces 12 to be gradually smaller toward the one wall part 2 side. In this manner, a gap between the fraction members 13 is shortened closer to the one wall part 2 side. That is, the number of the fraction members 13 for supporting the one wall part 2 can be increased. In this manner, the wall part 2 can be sufficiently supported by each of the fraction members 13. In addition, the wall part 2 is sufficiently supported by each of the fraction members 13. Therefore, a configuration can be adopted so that preparing the support material for supporting the wall part 2 is not required when the heat insulating structure 10 is manufactured by using the three-dimensional additive manufacturing machine (3D printer). In this manner, carrying out work for removing the support material from the manufactured heat insulating structure 10 is not required. In addition, it is possible to reduce costs and time required for preparing the support material when the heat insulating structure is manufactured by using the 3D printer. Therefore, it is easy to integrally manufacture the wall parts 2 and 3 and the heat insulating structure 10.

For example, the partition space 12 can be a space having a grid shape, a truss shape, or a honeycomb shape.

When an inclination angle A with respect to a horizontal plane of each of the partition members 11 is 45° or larger, each of the partition members 11 can be provided without preparing the support material inside each of the partition spaces 12 when the heat insulating structure 10 is manufactured by using the 3D printer. In this manner, the support material is not generated inside the partition space 12. Therefore, air can be more sufficiently interposed inside the partition space 12. In this manner, a portion between the two wall parts 2 and 3 can be more sufficiently insulated. In addition, the support material is not generated. Therefore, manufacturing costs and manufacturing time can be further reduced.

In the above-described embodiment, a case where the heat insulating structure is applied to the pipe serving as the heat insulating body has been described as an example. However, the present disclosure is not limited thereto. Specifically, the heat insulating structure may be applied to a box-shaped structure or a flat plate.

The heat insulating structure of the present disclosure as described above is suitably applicable to pipes, housings, or buildings requiring heat insulation from an external environment.

[Method for Manufacturing Heat Insulating Structure]

Next, a method for manufacturing the heat insulating structure according to the present embodiment will be described.

Hereinafter, a case of manufacturing the heat insulating structure applied to the pipe illustrated in FIG. 1A will be described as an example. However, the present disclosure is not limited thereto.

(Partitioning Step)

In a partitioning step, the plurality of partition members 11 are provided in a mesh shape in the space region 5 between the skin layer 2 and the skin layer 3. The space region 5 is partitioned into the plurality of partition spaces 12 from the skin layer 3 side to the skin layer 2 side. The inclination angle A with respect to the horizontal plane in each of the partition members 11 is 45° or larger.

(Fraction Step)

In a fraction step, the plurality of fraction members 13 are provided in the upper part of the cross section of the pipe 1 to support the skin layer 2 in the partition space 12 facing the skin layer 2 among the plurality of partition spaces 12. In this manner, the partition space 12 facing the skin layer 2 is fractionized to be gradually smaller toward the skin layer 2 side.

According to the present embodiment, the following operational effects are achieved by the above-described configuration.

The method for manufacturing the heat insulating structure 10 of the present embodiment includes the partitioning step of providing the plurality of partition members 11 in a mesh shape in the space region 5 between the two wall parts 2 and 3 (one wall part 2 and the other wall part 3), and partitioning the space region 5 into the plurality of partition spaces 12. In this manner, a portion between the two wall parts 2 and 3 can be sufficiently supported by the plurality of partition members 11. The partition member 11 has a sparse structure having the mesh shape. Therefore, air can be sufficiently interposed between the respective partition spaces 12. In this manner, the portion between the two wall parts 2 and 3 can be sufficiently insulated.

The method for manufacturing the heat insulating structure 10 of the present embodiment includes the fraction step of providing the plurality of fraction members 13 to support the one wall part 2 in the partition space 12 facing the one wall part 2 among the plurality of partition spaces 12, and fractionizing the partition space 12 to be gradually smaller toward the one wall part 2 side. In this manner, a gap between the fraction members 13 is shortened closer to the one wall part 2 side. That is, the number of the fraction members 13 for supporting the one wall part 2 can be increased. In this manner, the wall part 2 can be sufficiently supported by each of the fraction members 13. In addition, the wall part 2 is sufficiently supported by each of the fraction members 13. Therefore, a configuration can be adopted so that preparing the support material for supporting the wall part 2 is not required when the heat insulating structure 10 is manufactured by using the 3D printer. In this manner, carrying out work for removing the support material from the manufactured heat insulating structure 10 is not required. In addition, it is possible to reduce costs and time required for preparing the support material when the heat insulating structure is manufactured by using the 3D printer. Therefore, it is easy to integrally manufacture the wall part 2 and the heat insulating structure 10.

When the inclination angle with respect to the horizontal plane in each of the partition members 11 is 45° or larger, each of the partition members 11 can be provided without preparing the support material inside each of the partition spaces 12 when the heat insulating structure 10 is manufactured by using the 3D printer. In this manner, the support material is not generated inside the partition space 12. Therefore, air can be more sufficiently interposed inside the partition space 12. In this manner, a portion between the two wall parts 2 and 3 can be more sufficiently insulated. In addition, the support material is not generated. Therefore, manufacturing costs and manufacturing time can be further reduced.

In the present embodiment, the skin layers 2 and 3 and the heat insulating structure 10 can be integrally manufactured. In this case, the pipe 1 serving as the heat insulating body can be manufactured without generating the support material between the skin layer 2 and the heat insulating structure 10. Therefore, it is easy to integrally manufacture the skin layers 2 and 3 and the heat insulating structure 10, particularly when the heat insulating structure 10 is manufactured by using the 3D printer. In this manner, labor costs and operation time can be reduced.

### Second Embodiment

[Heat Insulating Body]

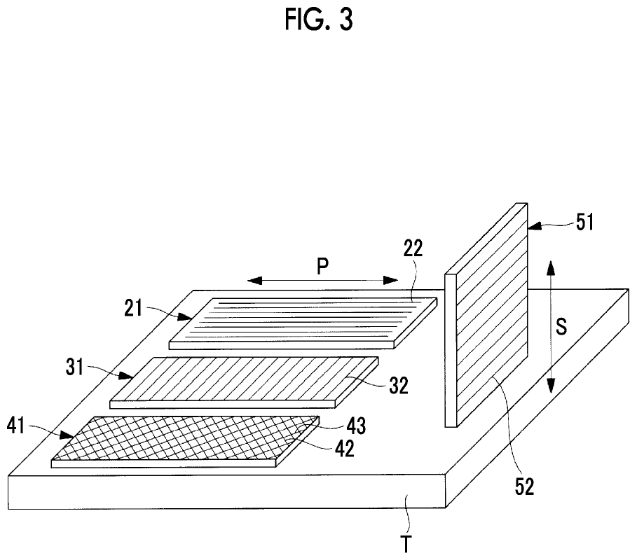

Next, a second embodiment of the present disclosure will be described with reference to FIGS. 3 to 5B. The heat insulating body according to the present embodiment is formed of a solid fiber reinforced material, and the fiber reinforced material includes a fiber whose orientation is aligned in a specific direction.

FIG. 3 is a perspective view illustrating a state where the heat insulating bodies according to the present embodiment are aligned.

On the left side in FIG. 3, flat plate-shaped heat insulating bodies 21, 31, and 41 are aligned to be parallel to a table T in order from a back side. The heat insulating body 21 includes a fiber 22 whose orientation is aligned in a direction parallel to an in-plane direction P (in-plane) (0°. The heat insulating body 31 includes a fiber 32 whose orientation is aligned in a direction (in-plane)(90°) orthogonal to the in-plane direction P. Examples of the fibers 22 and 32 include a continuous carbon fiber.

In the heat insulating body 41, the fiber 42 whose orientation is aligned in one direction and the fiber 43 whose orientation is aligned in the other direction intersect with each other. Examples of the fibers 42 and 43 include a short fiber reinforced NYLON and PEEK-CF (short fiber reinforced PEEK).

On the right side in FIG. 3, a flat plate-shaped heat insulating body 51 is placed to be orthogonal to the table T. The heat insulating body 51 includes a fiber 52 whose orientation is aligned in a direction orthogonal to an out-of-plane direction S. Examples of the fiber 52 include a continuous carbon fiber.

The above-described heat insulating bodies 21, 31, 41, and 51 are formed of a fiber reinforced material. As the fiber reinforced material, a fiber reinforced resin is preferably used.

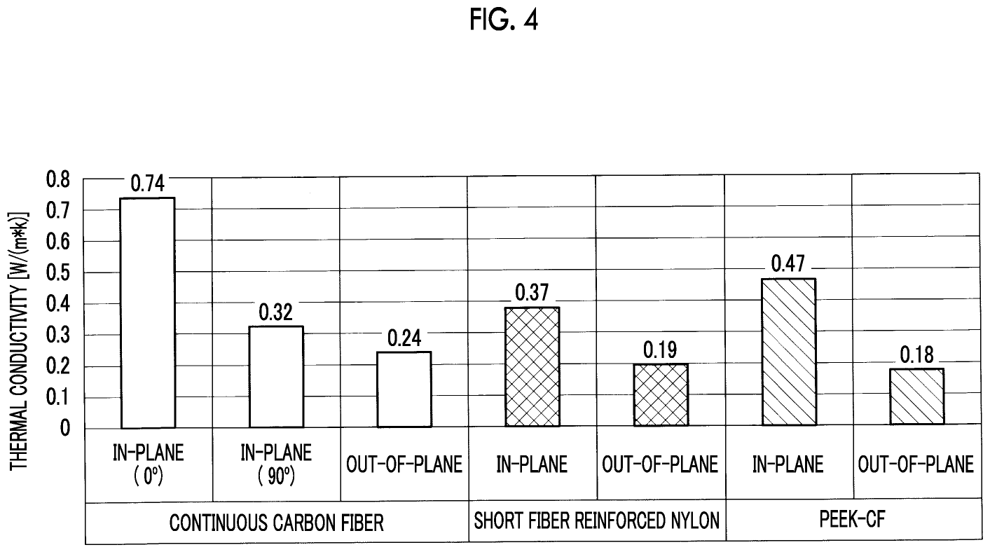

FIG. 4 is a graph illustrating results obtained by measuring thermal conductivity in the in-plane direction and the out-of-plane direction of the heat insulating body according to the present embodiment. As illustrated in FIG. 4, when the continuous carbon fiber is used as the fiber, with regard to the thermal conductivity in the in-plane direction, the thermal conductivity in a case where the orientation of the fiber is the direction parallel to the in-plane direction P (in-plane)(0°) is equal to or higher than twice the thermal conductivity in a case where the orientation of the fiber is the direction orthogonal to the in-plane direction P (in-plane) (90°). The thermal conductivity in the out-of-plane direction is much lower than the thermal conductivity in the in-plane direction) (90°).

Even when the short fiber reinforced NYLON or the PEEK-CF is used as the fiber, the thermal conductivity in the in-plane direction is approximately twice or equal to or higher than twice the thermal conductivity in the out-of-plane direction.

According to the above-described configuration, the fiber reinforced material forming the heat insulating body includes the fiber whose orientation is aligned in a specific direction. Accordingly, it can be understood that the heat insulating body having heat conduction anisotropy can be obtained.

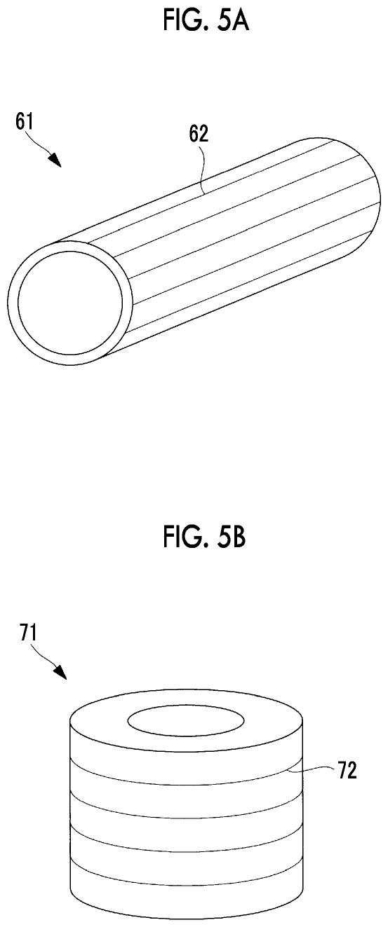

Examples of the heat insulating body using the heat conduction anisotropy in this way are illustrated in FIGS. 5A and 5B.

A pipe 61 serving as the heat insulating body illustrated in FIG. 5A includes a fiber 62 whose orientation is aligned in a direction parallel to the longitudinal direction of the pipe 61. In the pipe 61, whereas the thermal conductivity in the longitudinal direction is high, the thermal conductivity in a circumferential direction and a radial direction is low. According to the pipe 61 configured in this way, it is possible to sufficiently suppress heat conduction to a fluid inside the pipe 61.

A pipe 71 serving as the heat insulating body illustrated in FIG. 5B includes a fiber 72 whose orientation is aligned in a direction parallel to the circumferential direction of the pipe 71. In the pipe 71, whereas the thermal conductivity in the circumferential direction is high, the thermal conductivity in the longitudinal direction and the radial direction is low. According to the pipe 71 configured in this way, it is possible to sufficiently suppress heat conduction to a fluid inside the pipe 71.

For example, the heat insulating body according to the present embodiment can be manufactured by using the 3D printer. For example, an example of the 3D printer includes the 3D printer 100 in FIG. 2A described above. The above-described thermal conductivity anisotropy is especially evident in modeling of the 3D printer which strongly sets the orientation of the fiber.

An operation and an advantageous effect of the heat insulating bodies 21, 31, 41, 51, 61, and 71 according to the above-described present embodiment will be described.

The heat insulating bodies 21, 31, 41, 51, 61, and 71 according to the present embodiment are formed of a solid fiber reinforced material, and the fiber reinforced material includes the fibers 22, 32, 42, 52, 62, and 72 whose orientations are aligned in the specific direction. In this manner, the heat insulating bodies 21, 31, 41, 51, 61, and 71 can have the heat conduction anisotropy. Therefore, for example, when the pipes 61 and 71 are manufactured as the heat insulating body, it is possible to manufacture the pipe 61 in which the thermal conductivity in the circumferential direction and the radial direction is lowered by raising the thermal conductivity in the longitudinal direction, and the pipe 71 in which thermal conductivity in the longitudinal direction and the radial direction is lowered by raising the thermal conductivity in the circumferential direction. According to the pipes 61 and 71 configured in this way, it is possible to sufficiently suppress heat conduction to a fluid inside the pipes 61 and 71. In particular, when the heat insulating structure 10 is manufactured by using the 3D printer, the 3D printer easily aligns the orientations of the fibers 22, 32, 42, 52, 62, and 72 in the specific direction. Therefore, the heat insulating bodies 21, 31, 41, 51, 61, and 71 can easily have the heat conduction anisotropy.

The fiber reinforced material may include only the fibers 22, 32, and 52 whose orientations are aligned in one direction, or may include those in which the fiber 42 whose orientation is aligned in one direction and the fiber 43 whose orientation is aligned in the other direction intersect with each other.

In the above-described embodiment, a case where the heat insulating body is formed of the solid fiber reinforced material has been described as an example. However, the present disclosure is not limited thereto. Specifically, an aspect may be adopted so that the one wall part, the other wall part, or the heat insulating structure according to the above-described first embodiment is formed of the fiber reinforced material including the fiber whose orientation is aligned in the specific direction.

[Method for Manufacturing Heat Insulating Body]

Next, a method for manufacturing the heat insulating body according to the present embodiment will be described.

Hereinafter, a case of manufacturing the pipe 61 illustrated in FIG. 5A will be described as an example. However, the present disclosure is not limited thereto.

In manufacturing the pipe 61, the pipe 61 is formed of the solid fiber reinforced material including the fiber 62 whose orientation is aligned in the specific direction. Specifically, the pipe 61 is manufactured so that the orientation of the fiber 62 is aligned in a direction parallel to the longitudinal direction of the pipe 61 to be manufactured. For example, as the fiber reinforced material, a fiber reinforced resin is used.

According to the present embodiment, the following operational effects are achieved by the above-described configuration.

The method for manufacturing the heat insulating bodies 21, 31, 41, 51, 61, and 71 of the present embodiment includes a step of forming the heat insulating body by using the solid fiber reinforced material including the fibers 22, 32, 42, 52, 62, and 72 whose orientations are aligned in the specific direction. In this manner, it is possible to manufacture the heat insulating bodies 21, 31, 41, 51, 61, and 71 having the heat conduction anisotropy. Therefore, for example, when the pipes 61 and 71 are manufactured as the heat insulating body, it is possible to manufacture the pipe 61 in which the thermal conductivity in the circumferential direction and the radial direction is lowered by raising the thermal conductivity in the longitudinal direction, and the pipe 71 in which thermal conductivity in the longitudinal direction and the radial direction is lowered by raising the thermal conductivity in the circumferential direction. According to the pipes 61 and 71 configured in this way, it is possible to sufficiently suppress heat conduction to a fluid inside the pipes 61 and 71. In particular, when the heat insulating structure 10 is manufactured by using the 3D printer, the 3D printer easily aligns the orientations of the fibers 22, 32, 42, 52, 62, and 72 in the specific direction. Therefore, the heat insulating bodies 21, 31, 41, 51, 61, and 71 can easily have the heat conduction anisotropy.

For example, the heat insulating structure (10) described in each of the above-described embodiments is recognized as follows.

The heat insulating structure (10) according to the present disclosure includes the plurality of partition members (11) provided in a mesh shape in the space region (5) between the one wall part (2) and the other wall part (3) facing the one wall part, and partitioning the space region into the plurality of partition spaces (12) from a side of the other wall part to a side of the one wall part, and the plurality of fraction members (13) provided to support the one wall part, and fractionizing the partition space facing the one wall part among the plurality of partition spaces to be gradually smaller toward the side of the one wall part.

The heat insulating structure of the present disclosure includes the plurality of partition members provided in a mesh shape in the space region between the two wall parts (one wall part and the other wall part), and partitioning the space region into the plurality of partition spaces. In this manner, a portion between the two wall parts can be sufficiently supported. The partition member has a sparse structure having the mesh shape. Therefore, air can be sufficiently interposed in each of the partition spaces. In this manner, the portion between the two wall parts can be sufficiently insulated.

The heat insulating structure of the present disclosure includes the plurality of fraction members provided to support the one wall part, and fractionizing the partition space facing the one wall part among the plurality of partition spaces to be gradually smaller toward the side of the one wall part. In this manner, a gap between the fraction members is shortened closer to the side of the one wall part. That is, the number of the fraction members for supporting the one wall part can be increased. In this manner, the wall part can be sufficiently supported by each of the fraction members. In addition, the wall part is sufficiently supported by each of the fraction members. Therefore, a configuration can be adopted so that preparing the support material for supporting the wall part is not required when the heat insulating structure is manufactured by using the three-dimensional additive manufacturing machine (3D printer). In this manner, carrying out work for removing the support material from the manufactured heat insulating structure is not required. In addition, it is possible to reduce costs and time required for preparing the support material when the heat insulating structure is manufactured by using the 3D printer. Therefore, it is easy to integrally manufacture the wall part and the heat insulating structure.

For example, the partition space can be a space having a grid shape, a truss shape, or a honeycomb shape.

In the heat insulating structure according to the present disclosure, the inclination angle with respect to the horizontal plane among the plurality of partition members is 45° or larger.

When the inclination angle with respect to the horizontal plane in each of the partition members is 45° or larger, each of the partition members can be provided without preparing the support material inside each of the partition spaces when the heat insulating structure is manufactured by using the 3D printer. In this manner, the support material is not generated inside the partition space. Therefore, air can be more sufficiently interposed inside the partition space. In this manner, the portion between the two wall parts can be more sufficiently insulated. In addition, the support material is not generated. Therefore, manufacturing costs and manufacturing time can be further reduced.

The heat insulating body (1) according to the present disclosure includes the one wall part (2), the other wall part (3) facing the one wall part, and the above-described heat insulating structure (10) provided in the space region (5) between the one wall part and the other wall part. The one wall part, the other wall part, or the heat insulating structure is formed of the fiber reinforced material. The fiber reinforced material includes the fiber whose orientation is aligned in the specific direction.

In the heat insulating body of the present disclosure, the wall part and the heat insulating structure are formed of the fiber reinforced material, and the fiber reinforced material includes the fiber whose orientation is aligned in the specific direction. In this manner, the heat insulating body can have the heat conduction anisotropy. Therefore, for example, when the pipe is manufactured as the heat insulating body, it is possible to manufacture the pipe in which the thermal conductivity in the circumferential direction and the radial direction is lowered by raising the thermal conductivity in the longitudinal direction, and the pipe in which thermal conductivity in the longitudinal direction and the radial direction is lowered by raising the thermal conductivity in the circumferential direction. According to the pipe configured in this way, it is possible to sufficiently suppress heat conduction to the fluid inside the pipe. In particular, when the heat insulating structure is manufactured by using the 3D printer, the 3D printer easily aligns the orientation of the fiber in the specific direction. Therefore, the heat insulating body can easily have the heat conduction anisotropy.

The fiber reinforced material may include only the fiber whose orientation is aligned in one direction, or may include those in which the fiber whose orientation is aligned in one direction and the fiber whose orientation is aligned in the other direction intersect with each other.

The heat insulating body (21, 31, 41, 51, 61, and 71) according to the present disclosure is formed of the solid fiber reinforced material, and the fiber reinforced material includes the fiber (22, 32, 42, 52, 62, and 72) whose orientation is aligned in the specific direction.

The heat insulating body of the present disclosure is formed of the solid fiber reinforced material, and the fiber reinforced material includes the fiber whose orientation is aligned in the specific direction. In this manner, the heat insulating body can have the heat conduction anisotropy. Therefore, for example, when the pipe is manufactured as the heat insulating body, it is possible to manufacture the pipe in which the thermal conductivity in the circumferential direction and the radial direction is lowered by raising the thermal conductivity in the longitudinal direction, and the pipe in which thermal conductivity in the longitudinal direction and the radial direction is lowered by raising the thermal conductivity in the circumferential direction. According to the pipe configured in this way, it is possible to sufficiently suppress heat conduction to the fluid inside the pipe. In particular, when the heat insulating structure is manufactured by using the 3D printer, the 3D printer easily aligns the orientation of the fiber in the specific direction. Therefore, the heat insulating body can easily have the heat conduction anisotropy.

The fiber reinforced material may include only the fiber whose orientation is aligned in one direction, or may include those in which the fiber whose orientation is aligned in one direction and the fiber whose orientation is aligned in the other direction intersect with each other.

The method for manufacturing the heat insulating structure (10) of the present disclosure includes a partitioning step of providing the plurality of partition members (11) in a mesh shape in the space region (5) between the one wall part (2) and the other wall part (3) facing the one wall part, and partitioning the space region into the plurality of partition spaces (12) from a side of the other wall part to a side of the one wall part, and a fraction step of providing the plurality of fraction members (13) to support the one wall part in the partition space facing the one wall part among the plurality of partition spaces, and fractionizing the partition space facing the one wall part to be gradually smaller toward the side of the one wall part.

The method for manufacturing the heat insulating structure of the present disclosure includes the partitioning step of providing the plurality of partition members in a mesh shape in the space region between the two wall parts (one wall part and the other wall part), and partitioning the space region into the plurality of partition spaces. In this manner, the portion between the two wall parts can be sufficiently supported by the plurality of partition members. The partition member has a sparse structure having the mesh shape. Therefore, air can be sufficiently interposed in each of the partition spaces. In this manner, the portion between the two wall parts can be sufficiently insulated.

The method for manufacturing the heat insulating structure of the present disclosure includes the fraction step of providing the plurality of fraction members to support the one wall part in the partition space facing the one wall part among the plurality of partition spaces, and fractionizing the partition space to be gradually smaller toward the side of the one wall part. In this manner, a gap between the fraction members is shortened closer to the side of the one wall part. That is, the number of the fraction members for supporting the one wall part can be increased. In this manner, the wall part can be sufficiently supported by each of the fraction members. In addition, the wall part is sufficiently supported by each of the fraction members. Therefore, a configuration can be adopted so that preparing the support material for supporting the wall part is not required when the heat insulating structure is manufactured by using the three-dimensional additive manufacturing machine (3D printer). In this manner, carrying out work for removing the support material from the manufactured heat insulating structure is not required. In addition, it is possible to reduce costs and time required for preparing the support material when the heat insulating structure is manufactured by using the 3D printer. Therefore, it is easy to integrally manufacture the wall part and the heat insulating structure.

For example, the partition space can be a space having a grid shape, a truss shape, or a honeycomb shape.

In the method for manufacturing the heat insulating structure of the present disclosure, in the partitioning step, the inclination angle with respect to the horizontal plane among the plurality of partition members is 45° or larger.

When the inclination angle with respect to the horizontal plane in each of the partition members is 45° or larger, each of the partition members can be provided without preparing the support material inside each of the partition spaces when the heat insulating structure is manufactured by using the 3D printer. In this manner, the support material is not generated inside the partition space. Therefore, air can be more sufficiently interposed inside the partition space. In this manner, the portion between the two wall parts can be more sufficiently insulated. In addition, the support material is not generated. Therefore, manufacturing costs and manufacturing time can be further reduced.

According to the method for manufacturing the heat insulating body (1) of the present disclosure, in the method for manufacturing the heat insulating body including the one wall part (2), the other wall part (3) facing the one wall part, and the above-described heat insulating structure (10) provided in the space region (5) between the one wall part and the other wall part, the one wall part, the other wall part, and the heat insulating structure are integrally manufactured.

According to the method for manufacturing the heat insulating body of the present disclosure, the heat insulating body can be manufactured without generating the support material between the one wall part and the heat insulating structure. Therefore, it is easy to integrally manufacture the wall part and the heat insulating structure, particularly when the heat insulating structure is manufactured by using the 3D printer. In this manner, labor costs and operation time can be reduced.

According to the method for manufacturing the heat insulating body (1) of the present disclosure, the method for manufacturing the heat insulating body including the one wall part (2), the other wall part (3) facing the one wall part, and the above-described heat insulating structure (10) provided in the space region (5) between the one wall part and the other wall part includes a step of forming the one wall part, the other wall part, or the heat insulating structure by using the fiber reinforced material including the fiber whose orientation is aligned in the specific direction.

The method for manufacturing the heat insulating body of the present disclosure includes the step of forming the wall part of the heat insulating body or the heat insulating structure by using the fiber reinforced material including the fiber whose orientation is aligned in the specific direction. In this manner, it is possible to manufacture the heat insulating body having the heat conduction anisotropy. Therefore, for example, when the pipe is manufactured as the heat insulating body, it is possible to manufacture the pipe in which the thermal conductivity in the circumferential direction and the radial direction is lowered by raising the thermal conductivity in the longitudinal direction, and the pipe in which thermal conductivity in the longitudinal direction and the radial direction is lowered by raising the thermal conductivity in the circumferential direction. According to the pipe configured in this way, it is possible to sufficiently suppress heat conduction to the fluid inside the pipe. In particular, when the heat insulating structure is manufactured by using the 3D printer, the 3D printer easily aligns the orientation of the fiber in the specific direction. Therefore, the heat insulating body can easily have the heat conduction anisotropy.

The method for manufacturing the heat insulating body (21, 31, 41, 51, 61, and 71) of the present disclosure includes a step of forming the heat insulating body by using the solid fiber reinforced material including the fiber (22, 32, 42, 52, 62, and 72) whose orientation is aligned in the specific direction.

The method for manufacturing the heat insulating body of the present disclosure includes the step of forming the heat insulating body by using the solid fiber reinforced material including the fiber whose orientation is aligned in the specific direction. In this manner, it is possible to manufacture the heat insulating body having the heat conduction anisotropy. Therefore, for example, when the pipe is manufactured as the heat insulating body, it is possible to manufacture the pipe in which the thermal conductivity in the circumferential direction and the radial direction is lowered by raising the thermal conductivity in the longitudinal direction, and the pipe in which thermal conductivity in the longitudinal direction and the radial direction is lowered by raising the thermal conductivity in the circumferential direction. According to the pipe configured in this way, it is possible to sufficiently suppress heat conduction to the fluid inside the pipe. In particular, when the heat insulating structure is manufactured by using the 3D printer, the 3D printer easily aligns the orientation of the fiber in the specific direction. Therefore, the heat insulating body can easily have the heat conduction anisotropy.

### REFERENCE SIGNS LIST

1 Pipe (Heat insulating body)
2 Skin layer (One wall part)
3 Skin layer (The other wall part)
4 Flow path
5 Space region
10 Heat insulating structure
11 Partition member
12 Partition space
13 Fraction member
21, 31, 41, 51 (Flat plate-shaped) Heat insulating body
22, 32, 42, 52, 62, 72 Fiber
61, 71 Pipe (Heat insulating body)
100 3D printer (Three-dimensional additive manufacturing machine)
101 Housing
102 Modeling table
103 Modeling head
104 Reel
105 Plastic filament
105′ Plastic filament (in a molten state or a semi-molten state)
106 Support material filament
107 Nozzle
A Inclination angle
G Gap
M Modeled object
P In-plane direction
S Out-of-plane direction
T Table

1. A heat insulating structure comprising:
a plurality of partition members provided in a mesh shape in a space region between one wall part and the other wall part facing the one wall part, and partitioning the space region into a plurality of partition spaces from a side of the other wall part to a side of the one wall part; and
a plurality of fraction members provided to support the one wall part, and fractionizing the partition space facing the one wall part among the plurality of partition spaces to be gradually smaller toward the side of the one wall part.

2. The heat insulating structure according to claim 1,
wherein an inclination angle of the plurality of partition members with respect to a horizontal plane is 45° or larger.

3. A heat insulating body comprising:
one wall part;
the other wall part facing the one wall part; and
the heat insulating structure according to claim 1, which is provided in a space region between the one wall part and the other wall part,
wherein the one wall part, the other wall part, or the heat insulating structure is formed of a fiber reinforced material, and
the fiber reinforced material includes a fiber whose orientation is aligned in a specific direction.

4. A heat insulating body formed of a solid fiber reinforced material,
wherein the fiber reinforced material includes a fiber whose orientation is aligned in a specific direction.

5. A method for manufacturing a heat insulating structure, comprising:
a partitioning step of providing a plurality of partition members in a mesh shape in a space region between one wall part and the other wall part facing the one wall part, and partitioning the space region into a plurality of partition spaces from a side of the other wall part to a side of the one wall part; and
a fraction step of providing a plurality of fraction members to support the one wall part in the partition space facing the one wall part among the plurality of partition spaces, and fractionizing the partition space facing the one wall part to be gradually smaller toward the side of the one wall part.

6. The method for manufacturing a heat insulating structure according to claim 5,
wherein in the partitioning step, an inclination angle of the plurality of partition members with respect to a horizontal plane is 45° or larger.

7. A method for manufacturing a heat insulating body including one wall part, the other wall part facing the one wall part, and the heat insulating structure according to claim 1, which is provided in the space region between the one wall part and the other wall part,
wherein the one wall part, the other wall part, and the heat insulating structure are integrally manufactured.

8. A method for manufacturing a heat insulating body including one wall part, the other wall part facing the one wall part, and the heat insulating structure according to claim 1, which is provided in the space region between the one wall part and the other wall part, the method comprising:
a step of forming the one wall part, the other wall part, or the heat insulating structure by using a fiber reinforced material including a fiber whose orientation is aligned in a specific direction.

9. A method for manufacturing a heat insulating body, comprising:
a step of forming the heat insulating body by using a solid fiber reinforced material including a fiber whose orientation is aligned in a specific direction.

10. A heat insulating body comprising:
one wall part;
the other wall part facing the one wall part; and
the heat insulating structure according to claim 2, which is provided in a space region between the one wall part and the other wall part,
wherein the one wall part, the other wall part, or the heat insulating structure is formed of a fiber reinforced material, and
the fiber reinforced material includes a fiber whose orientation is aligned in a specific direction.

11. A method for manufacturing a heat insulating body including one wall part, the other wall part facing the one wall part, and the heat insulating structure according to claim 2, which is provided in the space region between the one wall part and the other wall part,
wherein the one wall part, the other wall part, and the heat insulating structure are integrally manufactured.

12. A method for manufacturing a heat insulating body including one wall part, the other wall part facing the one wall part, and the heat insulating structure according to claim 2, which is provided in the space region between the one wall part and the other wall part, the method comprising:
a step of forming the one wall part, the other wall part, or the heat insulating structure by using a fiber reinforced material including a fiber whose orientation is aligned in a specific direction.
